(19) United States
(12) Patent Application Publication
(10) Pub. No.: US 2012/0292219 A1
(43) Pub. Date: Nov. 22, 2012

(54) Top loading fluid vial housing

(76) Inventors: Robert Terwilliger, Palm Beach Gardens, FL (US); Richard Haskins, Palm Beach Gardens, FL (US)

(21) Appl. No.: 13/560,426

(22) Filed: Jul. 27, 2012

Related U.S. Application Data
(63) Continuation-in-part of application No. 13/036,935, filed on Feb. 28, 2011.
(60) Provisional application No. 61/362,667, filed on Jul. 8, 2010.

(51) Int. Cl. A61J 1/00; B65D 23/00; B65D 81/38; B65D 25/10

(52) U.S. Cl. 206/459.5; 220/600; 220/601; 215/40; 220/592.2

(57) ABSTRACT

A top loading container for housing a fluid vial is described. The top loading container includes a calculation aid formed specific to the fluid vial. The top loading container is formed from a bottom, a top, and an inset side wall there between. The top is adapted to be securable to a fluid vial so that the fluid vial rests in a suspended position within the interior of the top loading container. An inner label is permanently attached to the sidewall having at least one row of dosing indicia coordinated with a base line indicia selected from the group of weight, age, fluid volume or area. An outer label is rotatably secured over the inner label with at least one transparent window allowing selective viewing of the dosing and base line indicia and predetermined dosing rate.

### PRIORITY CLAIM

This application is a continuation-in-part of U.S. patent application Ser. No. 13/036,935, filed Feb. 28, 2011, entitled “Injectable Fluid Vial Housing,” which claims a priority date of Jul. 8, 2010, based upon U.S. Provisional Patent Application No. 61/362,667 entitled “Injectable Fluid Vial Housing,” the contents of which are incorporated herein by reference.

### FIELD OF THE INVENTION

This invention relates generally to fluid vials potentially containing medicine, vital fluids, and/or nutritional supplements and, more particularly, to a top loading fluid vial container for containing a fluid vial that incorporates information, such as a calculation aid to provide dosage level based upon weight, age, volume, or area, or product information.

### BACKGROUND OF THE INVENTION

Dosing of injectable fluids by prescription based upon a patient's weight, age or other means of estimating the patient's fluid volume is known in the art. However, the means of calculation the dosing amount is cumbersome and potentially contributing to the incorrect dosing of an intended recipient should any of the base line factors change or an error made in calculation.

Although methods are known by which dose calculating aides may be integrated with typically sized bottles, injectable fluid vials tend to be substantially smaller and thereby greatly limit the practical area available to do so.

The currently available dosage calculations presented on charts and pinwheels are not readily available to the general public. Further, the dosage amount may be based on volume, area or age which can change leaving the individual to seek professional assistance to recalculate the dosage amount. Even if a physician's reference manual is available, the reference can present a confusing array of dosages that may not be understood by the general consumer.

For example, a first responder may carry a host of injectable fluids that are stored in vials to treat various types of accident victims. Upon reaching an accident victim, the first responder is assaulted with a confusing array of possible injuries yet is called upon to immediately provide relief for pain or otherwise stabilize the injured individuals. However, in the midst of the confusion a doctor may not be reached and the first responder may be called upon to determine dosage levels based upon weight, age, fluid volume or area. It is unrealistic to expect a first responder, or even a seasoned physician, to remember all the required doses for all injectable fluids.

The proper dosing of any medication is imperative as is the need to assure that the medication being injected will actually assist the patient. For this reason it is well recognized that dosing calculations performed well before application lessen the possibility of over/under dosing.

The Applicant recognized the need for proper elixir dosing based upon weight versus age for children. U.S. Pat. Nos. 6,276,533 and 6,581,773 discloses the need for a weight based dosing regimen for pediatric elixirs, and disclosed a container mounted rotating calculation aid to provide proper dosing at the time of delivery. It is now well recognized that a 12 year old boy may weight 60 lbs or 160 lbs wherein dosing based upon age could lead to over/under dosing.

A number of patents were issued to inventor Key which disclose an apparatus and method of constructing a rotating label system including U.S. Pat. Nos. 5,884,421; 6,086,697; 6,237,269; 6,631,578; 6,385,878; 6,402,872; 6,649,007; 7,087,298; and 7,172,668. The disclosures provide for a rotating label that is placed around a container, the rotating label including a viewing window to view indicia placed on an inner label. The patents are directed to a system and method for constructing a rotatable label and attaching the label to a container. Key does not disclose a container for housing another container, and thus would not disclose any teaching for the matching of two containers.

Tamper resistant vial containers are also known, such as the placement of a plastic or a metal seal over the mouth of the container beneath the screw cap. U.S. Pat. No. 4,871,977 discloses a barb or hook inside an open upper end of a vial, providing a cap adapted for insertion into the vial having a mating hook formed about a lower edge thereof, and providing sealing rings formed on the outer surface thereof, thereby yielding a tamper-resistant, leak-proof sealing between the enclosure and the vial.

U.S. Pat. Nos. 4,586,622 and 4,449,640 describe an open-top vial covered by a cap having a depending peripheral skirt, in such a way that an inner surface of the cap skirt and an outer surface of the cap are provided with complementary mating interlock elements. The cap comprises an integral tear member, defined by at least one weakened, partially circumferential weakened junction lines, such that pulling away the tear member along the junction line allows both annual removal of the cap and ready visual confirmation that vial integrity has been breached.

U.S. Pat. Nos. 4,211,333 and 4,306,357 disclose a vial having a flange about its opening so that, below the flange and spaced apart therefrom, a shoulder defines an indented neck therebetween. An overcap extends over the flange and about the neck to form a skirt about the neck. The skirt has at least a portion thereof extending inwardly in gripping reaction with the neck and limited in removal by contact with the underside of the flange, whereby the cap cannot be removed without destroying a structural integrity thereof.

No known prior art exists for combining a fluid vial, such as an injectable fluid vial with a top loading security container having a calculation aid for dosing.

### SUMMARY OF THE INVENTION

The present invention provides a top loading container for housing and maintaining an injectable fluid vial suspended within. The top loading container includes a calculation aid formed specific to the fluid vial. The top loading container is formed from a bottom, a top, and an inset side wall there between. The top is adapted to be securable to a fluid vial so that the fluid vial rests in a suspended position within the interior of the top loading container. An inner label is permanently attached to the sidewall having at least one row of dosing indicia coordinated with a base line indicia selected from the group of weight, age, fluid volume or area. An outer label is rotatably secured over the inner label with at least one transparent window allowing selective viewing of the dosing and base line indicia and predetermined dosing rate.

An objective of the instant invention is to provide a top loading container for a conventional fluid vial housing providing sufficient surface area for inclusion of printed indicia, such as a dosing calculation aid and providing a means of protecting the fluid vial from tampering.

Another objective of the invention is to provide a top loading container for a conventional injectable fluid vial housing providing sufficient surface area for inclusion of a dosing calculation aid and providing a means of protecting the fluid vial from tampering.

Still another objective of the invention is to provide a top loading container having an inset sidewall to allow for ease of rotation of a rotating dosing calculation aid.

Another objective of the instant invention is to provide a more accurate and/or convenient method by which injectable medication, vital fluid, and/or nutritional supplement dosing may be determined.

Yet still another objective of the invention is to provide a top loading container for a fluid vial housing or an injectable fluid vial housing that can be keyed so that it will only hold a particular fluid vial so as to reduce or eliminate the possibility that the wrong calculation aid is used with a fluid vial.

Another objective of the invention is to provide a top loading container having a lid that allows for securely engaging a portion of a fluid vial housing or an injectable fluid vial housing.

Yet another objective of the invention is to provide an insulated top loading container for a fluid vial housing or an injectable fluid vial housing wherein an insulator moderates fluid temperature change.

Still another objective of the invention is to provide a top loading container for a fluid vial housing or an injectable fluid vial housing that includes a first portion which engages a portion of a fluid vial housing or an injectable fluid vial housing to maintain the vial housing in a centrally disposed position.

Another objective of the invention is to provide a top loading container for a fluid vial housing or an injectable fluid vial housing which is tamper resistant.

Another objective of the invention is to provide a top loading container for a fluid vial housing or an injectable fluid vial housing having a lid that includes a tamper-evident cover.

Still another objective of the invention is to provide a top loading container that is economical to manufacture and recyclable.

Still another objective of the invention is to provide a top loading container which provides identification and other product information to a fluid vial housing or an injectable fluid vial housing having a surface which cannot be directly labeled.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a perspective view of a top loading container of the present invention holding a conventional injectable fluid vial housing;

FIG. 2 is a perspective view of a top loading container of the present invention;

FIG. 3 is a perspective view of a top loading container of the present invention with an illustrative example of a transition area formed at a right angle to the inset sidewall;

FIG. 4 is a cross sectional view of the top loading container of the present invention illustrating the lower portion secured to the upper portion;

FIG. 5 is a pictorial view of a conventional injectable fluid vial housing and a conventional syringe;

FIG. 6 is a perspective view of the top loading container of the instant invention with the upper portion removed;

FIG. 7 is a perspective view of the upper portion of the top loading container of the present invention;

FIG. 8 is a perspective view of the interior side of the upper portion of the top loading container of the present invention;

FIG. 9 is a perspective view of the top loading container, illustrating the use of spacers and a securing member;

FIG. 10 is a plane side view of the top loading container with a dosing label attached along a leading edge;

FIG. 11 is a plane front view of the dosing label;

FIG. 12 is a plane side view of the top loading container with the dosing label attached thereto;

FIG. 13 is a plane front view of an outer label;

FIG. 14 is a plane side view of the container with the outer label attached to the dosing label along a leading edge;

FIG. 15 is a plane side view of the container depicting a first dosing amount;

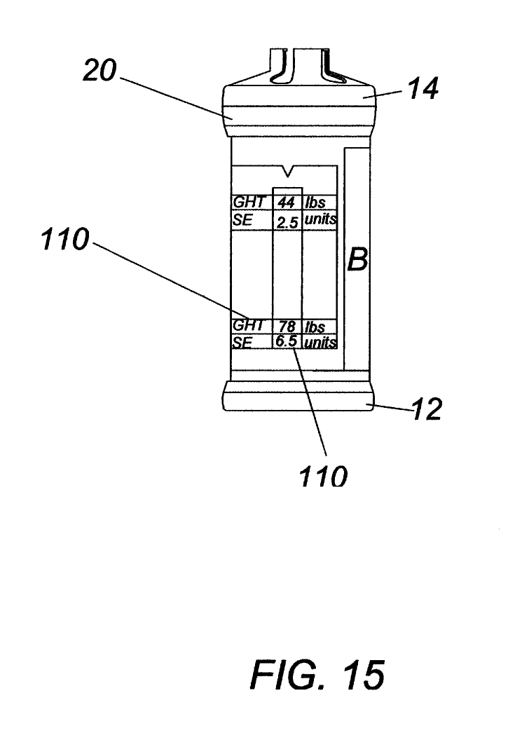

FIG. 16 is a plane side view of the container depicting a second dosing amount;

FIG. 17A is a perspective view of the top loading container of the present invention holding a conventional fluid vial housing shown with the upper portion secured to the bottle below a safety ring secured to the fluid vial housing cap;

FIG. 17B is a perspective view of the top loading container of the present invention holding a conventional fluid vial housing shown with the upper portion secured to the safety ring;

FIG. 17C is a perspective view of the top loading container of the present invention holding a conventional fluid vial housing shown with the upper portion secured to the conventional fluid vial housing at a position above the safety ring;

FIG. 18 is a perspective view of an embodiment formed from an upper portion having an extended continuous side wall;

FIG. 19 is a perspective view of an embodiment using a plurality of dosing labels.

### DETAILED DESCRIPTION OF THE PREFERRED EMBODIMENT

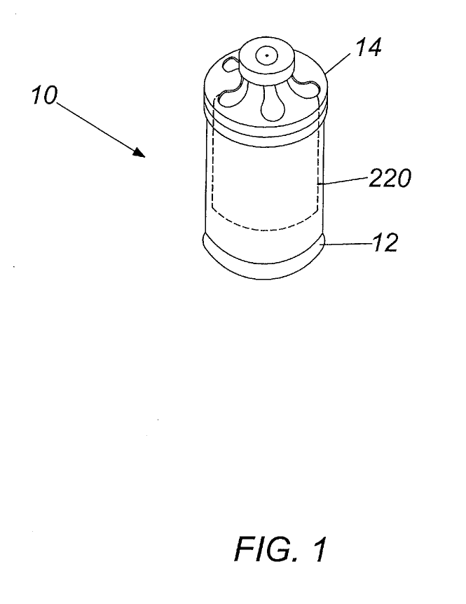

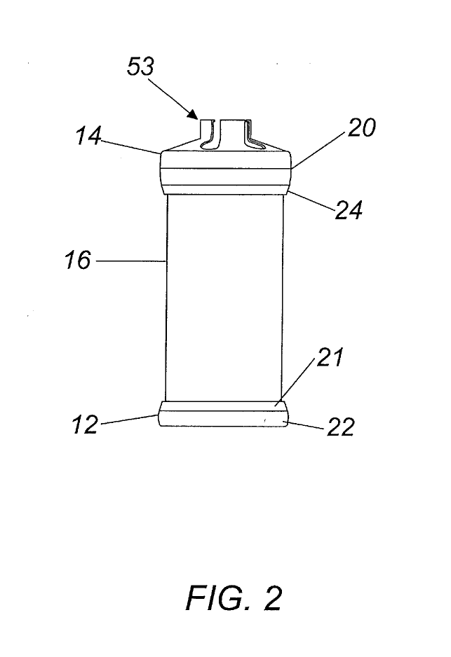

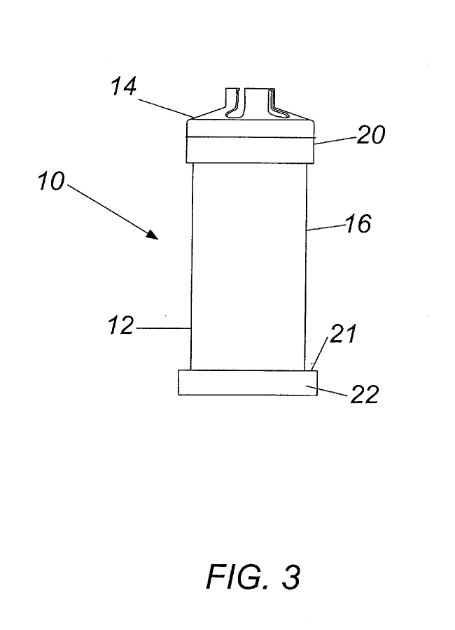

Referring to FIGS. 1-3, and 6 set forth is a top loading container 10 having a first lower portion 12 secured to a second upper portion 14. The first lower portion 12 is formed from a continuous inset sidewall 16 having a bottom 18 and a top 20. The bottom 18 may be attached to the inset sidewall 16 or preferably formed integral thereto having a lower transition area 21. The lower transition area 21 is formed by use of the inset sidewall 16 having an outer diameter less than the outer surface sidewall 22 of the bottom section 18. The transition area 21 may be formed at an angle to the inset sidewall 16 and outer surface sidewall 22. Preferably the transition area 21 is formed at a right angle to the inset sidewall 16 and the outer surface sidewall 22, see FIG. 3. Similarly an upper transition area 24 is formed at an angle, preferably at a right angle to the inset sidewall 16. The inset sidewall 16 has an outer diameter less than the outer surface sidewall 26 of the top section 20. The use of angled transition areas 21 and 24 allow the use of a rotating label, as will be further explained in this specification, with sufficient tolerance to allow ease of rotation without disengagement from the container.

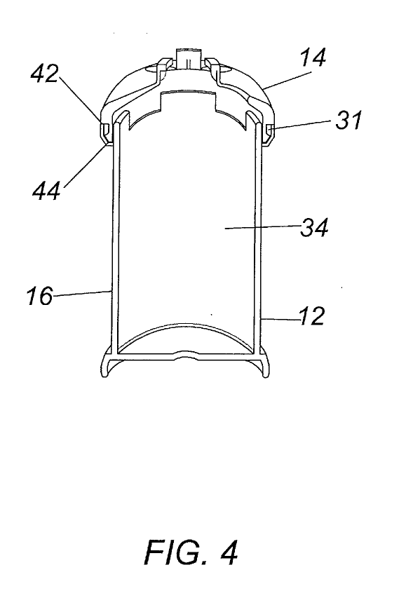

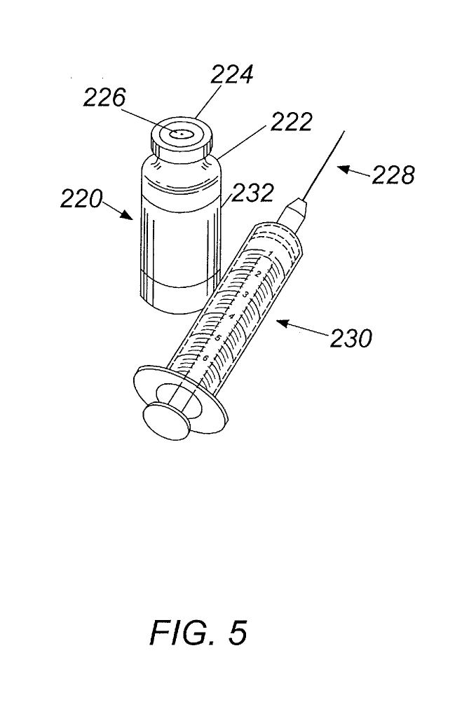

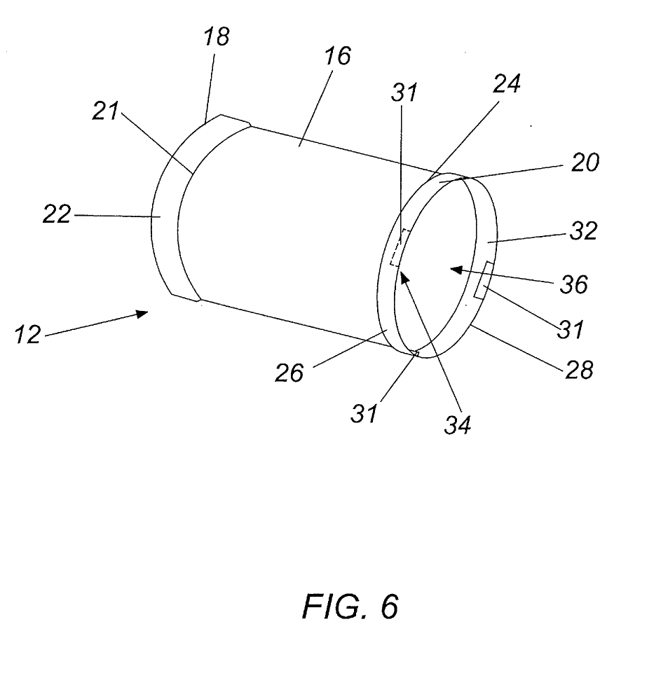

The top section 20 includes an access opening 28 constructed and arranged to receive and secure to the second upper portion 14, see FIG. 6. As an illustrative example, the upper portion 14 may be secured to the lower portion 12 through the use of one or more engagement tabs 31 positioned along the entry wall 32, see FIG. 4 or FIG. 6. The engagement tabs 31 allow upper portion 14 to frictionally engage a portion of the top section 20 to enclose the contents of the top loading container 10 within an interior 34. The entry wall 32 contains a ridge 36 which also helps to properly secure the second upper portion 14. The opening 28 on the top section 20 is sized for receipt of a conventional fluid vial, illustrated herein as an injectable vial 220, see FIG. 5. While the injectable fluid vial 220 is shown representing fluid vials, other bottle types, including those with screw tops and/or capable of holding various amounts of fluids, such as 25, 150, or 250 mL of fluids, can be contained within.

A conventional injectable vial has a glass body 222 with a needle piercing cap 224 having a grommet 226 that allows passage of a needle 128 from a conventional syringe 230. Fluid vials are typically small glass containers which are known for the non-leaching characteristics providing stability to the contents of the vial. Small vials are used due to the limited amount of fluids that are stored in the vial, due to expense, sterility, storage stability or any combination thereof. For instance, the vial may contain an injectable fluid that has a short shelf life or is temperature and light sensitive. The result is a fluid vial that is very small having limited room for a label 232. The problem with the vial being small is that the amount of information that could be placed on the label 132 can be limited. When dosing is required, such as during an emergency, the ability of the individual that is calculating the dosing amount must have readily access to the proper dosing level for the individual so as to allow for effective use of the fluid. In addition, some fluids stored within a fluid vial require that nothing be attached to the surface of the vial. While nothing can be attached to the vial surface, proper identification and delivery or use directions is needed. Such materials require an outside container for identification purposes. Use of a secondary bottle with outside labeling, however, runs the risk of mishandling and/or incomplete usage as the vial may be separated from the outside container. In cases of separation, the user is unaware of the contents of the liquid inside and must discard the vial for safety reasons.

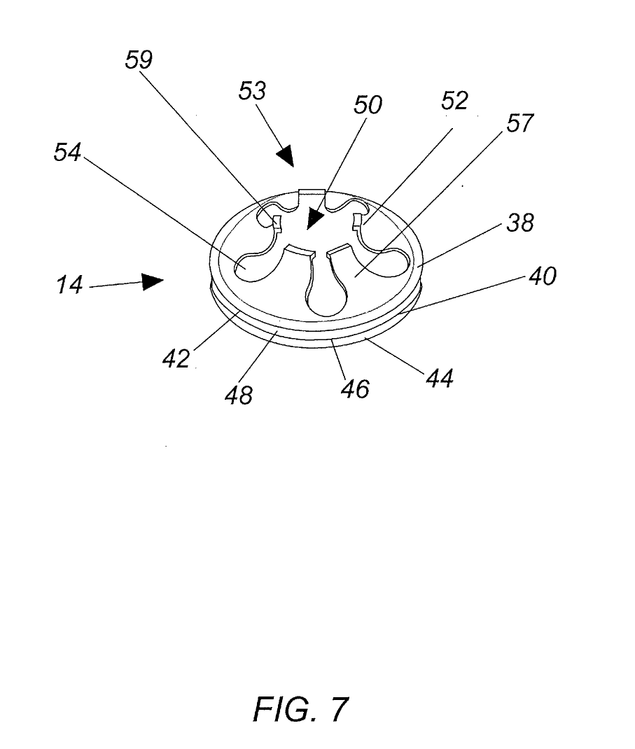

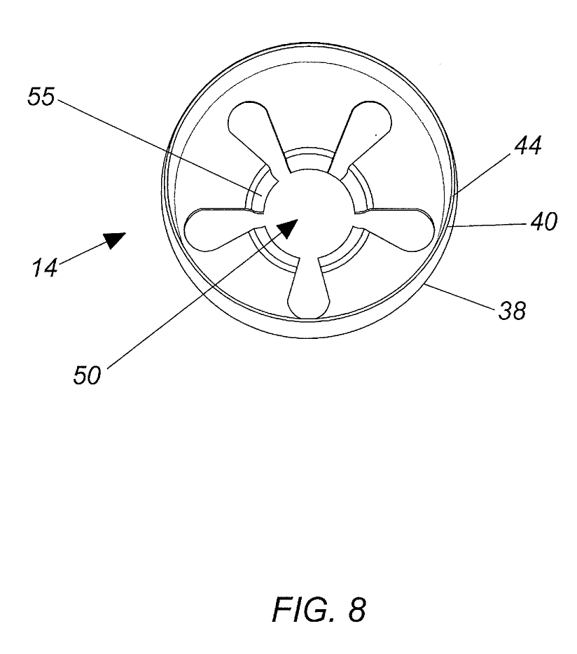

Referring to FIGS. 7 and 8, an illustrative example of the second upper portion 14 of the top loading container 10 in accordance with the present invention is shown. The second upper portion 14 is constructed and arranged to secure to the first lower portion 12 thereby forming an enclosed top loading container 10 and to secure to a conventional fluid vial, such as the injectable fluid vial 220 thereto. The second upper portion is formed from a continuous outer upper wall 38 having a larger diameter than a second continuous inner upper wall 40. The continuous outer upper wall 38 may be attached to the second continuous inner upper wall 40 or preferably formed integral thereto and extends away, in a downwardly direction, from the edge 42 of the continuous outer upper wall 38. At or near the second continuous inner upper wall edge 44 is a raised rim 46 which forms an inset region 48. When coupled to the first lower portion 12, the second continuous inner upper wall 40 is inserted within the opening 30 so that the engagement tabs 31 are aligned between the edge 42 continuous outer upper wall 38 and the second continuous inner upper wall edge 44, within the inset region 48. Once inserted, second upper portion may be 14 rotatable.

While such frictional fit coupling is illustrated, other mechanisms of securing the first lower portion 12 to the second upper portion 14 can be used. For example, the first lower portion 12 may contain tabs (not illustrated) constructed and arranged to be insertable within tab receiving areas (not illustrated) located within or along the second upper portion 14. Once inserted, the two sections are locked together. The first lower portion 12 may be released from the second upper portion 14 by engaging the tabs, such as through pushing them out of the tab receiving areas. Alternatively, the first lower portion 12 may contain internal, or female threading and the second upper portion 14 may contain external, or male threading. Once inserted, the second continuous inner upper wall edge 44 rests at or near the entry wall ridge 36.

The second upper portion 14 of the top loading container 10 contains an opening 50 sized and shaped to receive a fluid vial, such as the injectable fluid vial 220. As illustrated on FIG. 7 or 8, the opening 50 may be formed by a plurality of finger-like projections 52 arranged about to form a neck 53. The finger-like projections 52 are formed by cutout portions 54 which impart flexibility upon each individual finger-like projection 52. Insertion of the needle piercing cap 224 of the injectable fluid vial 220 allows each individual finger-like projection 52 to be pushed away from its original position, expanding the size of the neck 53 as the needle piercing cap 224 slides against the back surface 55 of each finger-like projection 52. The flexibility imparted to each finger-like projection 52 prevents projection failure, i.e. partial or complete breakage, during insertion. Once in position, the injectable fluid vial 220 is secured to the neck 53. Each of the individual finger-like projections 52 may be shaped to conform to the shape of the inserted fluid vial therein to provide for minimal contact between the vial and the second upper portion 14. As an illustrated example, the individual finger-like projections 52 contain a partial angled and/or curved surface 57 which is sized and shaped to contour to the curved upper portion of the injectable fluid vial 220. Each finger-like projection 52 may also contain an L-shaped terminal end 59 which further helps maintain a space between the sidewall and the injectable fluid vial. Such spacing further minimizes direct contact between the second upper portion 14 the injectable fluid vial 220.

The flexibility of the neck 53 further allows each finger-like projection 52 to snap back to its original configuration, thereby encircling the inserted injectable fluid vial 220. In this configuration, the injectable fluid vial 220 is secured to the second upper portion 14, suspending the injectable fluid vial 220 within the interior 34 of the top loading container 10. Preferably, when the second upper portion with the injectable fluid vial 220 secured thereto is inserted into the first bottom portion 12, a space is maintained between the injectable fluid vial 220 and the inner surface of the inset sidewall 16 and/or the continuous outer upper wall 38 and/or the second continuous inner upper wall 40. In this manner, there is minimal contact between the injectable fluid vial 220 and the top loading container 10. Additionally, the injectable fluid vial 220 is maintained suspended from the upper portion 14 and extending into the lower portion 14.

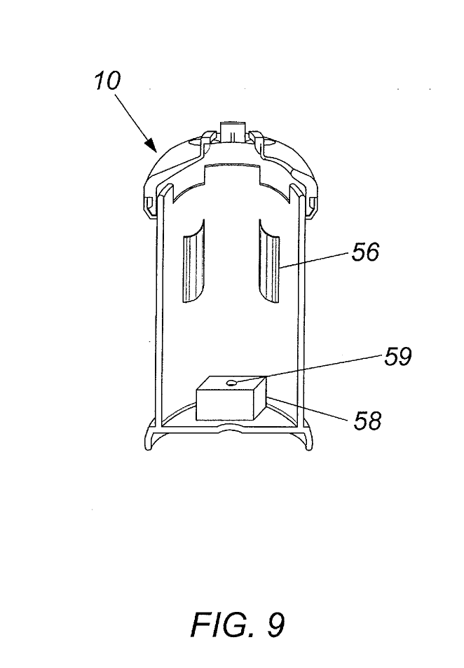

The top loading container 10 includes sufficient spacing around the fluid vial 220 to include insulation if fluid within the vial needs temperature stabilization. The top loading container 10 may further include bottle securing members, such as spacers 56 and/or or support structures such as a cushion 58 made of a material such as a soft pliable plastic pad or puck at the bottom so as to prevent the vial from movement, and reducing the likelihood of damage during transpiration, see FIG. 9. The spacers 56 flex to accommodate oversized fluid vials. The cushion 58 may contain a recessed area 59 sized and shaped to receive the inserted liquid vial.

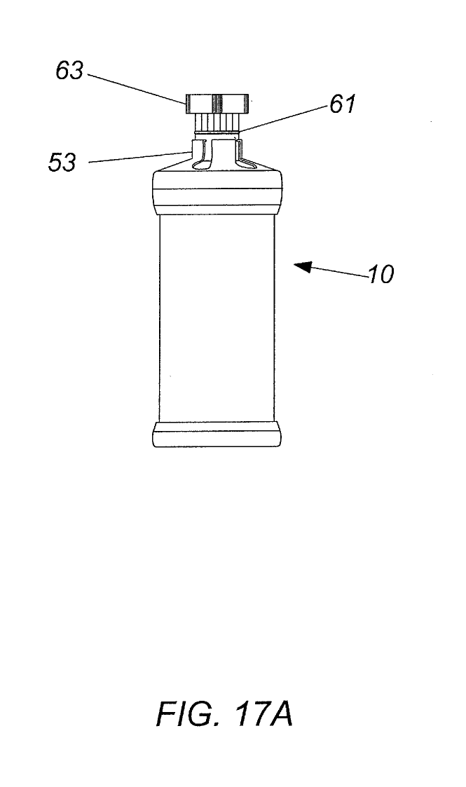

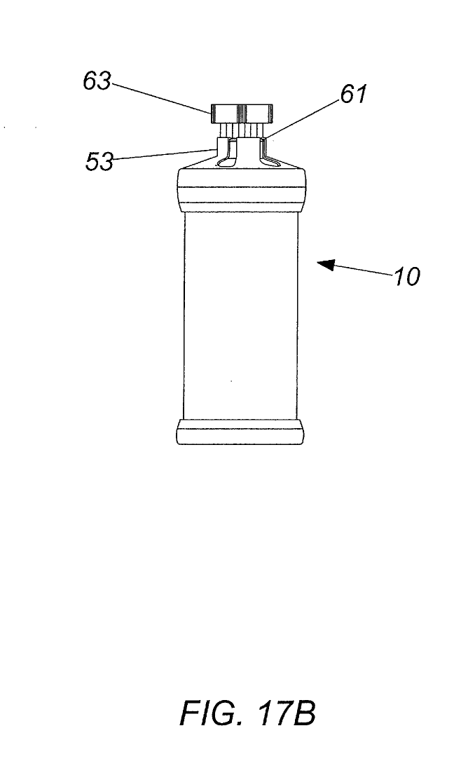

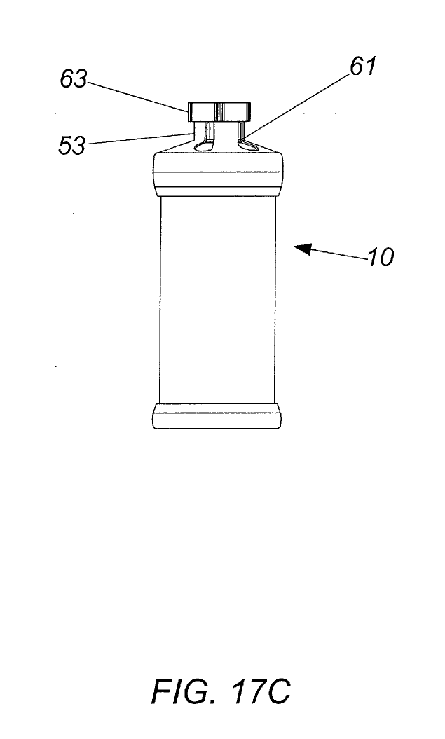

While the main function of the container will be for increasing the labeling readability and incorporation of a calculation aid, it should be noted that a container can also provide an anti-tamper lid such as a ratchet design, key lock opening, and so forth, not shown. Alternatively, the fluid vial inserted therein may include a safety lock ring. In such case, the neck 53 of the top loading container 10 may be attached to a liquid storage bottle above a safety seal ring 61 attached to a bottle top cap 63, see FIG. 17A, directly to the safety seal ring 61 via mechanical or chemical, i.e. adhesives, means known to one of skill in the art, see FIG. 17B, or above the locking ring 61, see FIG. 17C. Further, the use of plastic shrink wrap around the upper section 14 or where the upper section 14 and lower section 12 are secured provides evidence of improper tampering.

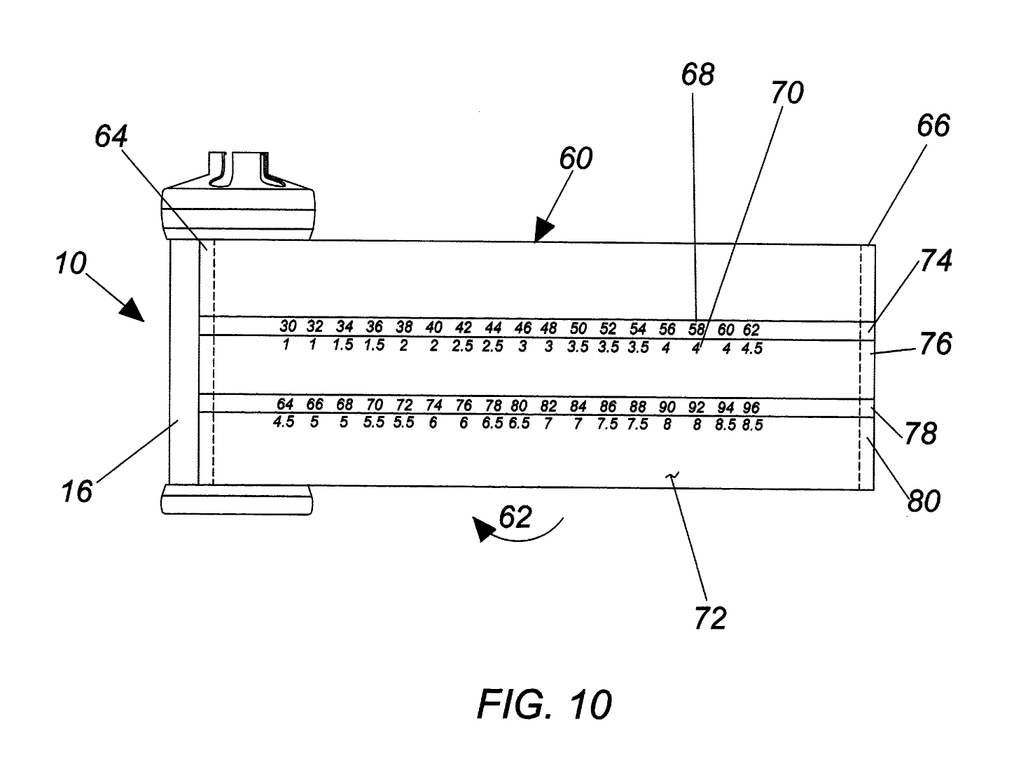

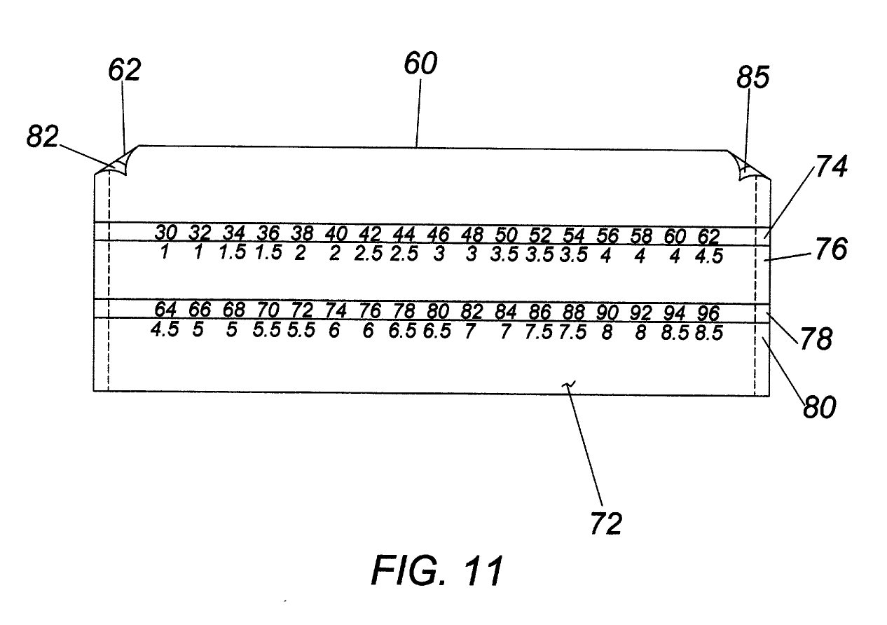

Referring now to FIGS. 10-12, the top loading container 10 has an inner label 60 attached to the inset sidewall 16 by placement of adhesive on the back 62 of a leading edge 64 secured to the inset sidewall 16. Similarly, adhesive is placed on the back 62 of a trailing edge 66 of the inner label 60. When the inner label 60 is wrapped around the top loading container 10 it is securely joined to the top loading container 10 in a permanent fashion.

The inner label 60 includes one or more types of indicia, such as multiple rows of weights 68 and dosing 70 indicia placed on the front surface 72. The indicia illustrated is for example only and can be displayed in volume, units, weight, age, ml, units, etc. . . . and any combination thereof that the manufacturer or physician employs. The example illustrated depicts a base line indicia 74 having children weights from 30 lbs to 62 lbs and a dosing line of indicia 76 being the calculated dose for an individual based upon the weight. For example a 58 lb child may be injected with 4 units of the contained fluid held within the vial 120.

Further to this example a second row 78 of indicia indicates weights from 64 lbs to 96 lbs and a dosing rate indicia line 80 of 4.5 units to 8.5 units. In this example an 82 lb child would have a dosing rate of 7 units. While the underlying label provides the dosing indicia on tables that can be commonly found in physicians handbooks, the particular label allows for customization of indicia that is appropriate only for fluid within the vial to allow the individual that will be injecting the fluid an instant reference of the appropriate amount without further calculation or reference materials. Various mechanisms can further be used to coordinate the container top loading 10 to the vial 220 including color coating of labels, color coating of containers, or coordinated sizes to make sure that the vial 220 and the top loading 10 are matched. The upper portion 14 and the lower portion 12 can be permanently secured to together so that the vial 220 secured within the top loading container 10 cannot be removed. In such a configuration, only the cap section 224 of the vial 220 is accessible. Further, the vial can be permanently captured within the container wherein the fluid is drawn directly from the grommet 226 without removal of the vial.

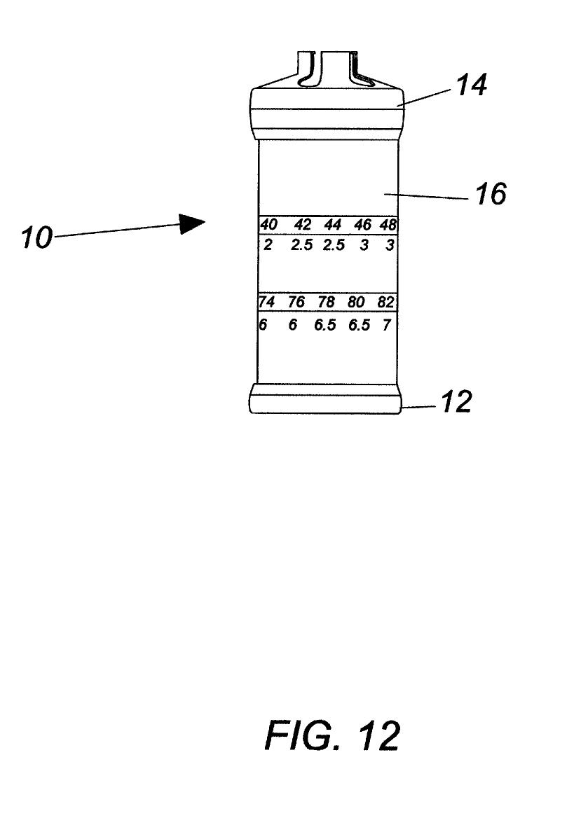

Label 60 includes the use of a permanent adhesive 82 along the leading edge 64 and adhesive 84 along the tailing edge 66. Alternatively the adhesive can be placed all across the back of the label 60; the amount of permanent adhesive to accomplish the necessary securement is dependent on the label material. A plastic film requires adhesive along the leading and trailing edges 64 and 66 respectively, as the film is resistant to tearing. A label made from thin paper will likely need adhesive on a substantial portion of the back surface 62 to prevent premature removal. Once the leading edge 64 is secured the label 60 is wrapped around the container, as shown in FIG. 12, with the trailing edge abutting the leading edge. The label 60 is held within the transition sections 21 and 24 covering the inset sidewall 16.

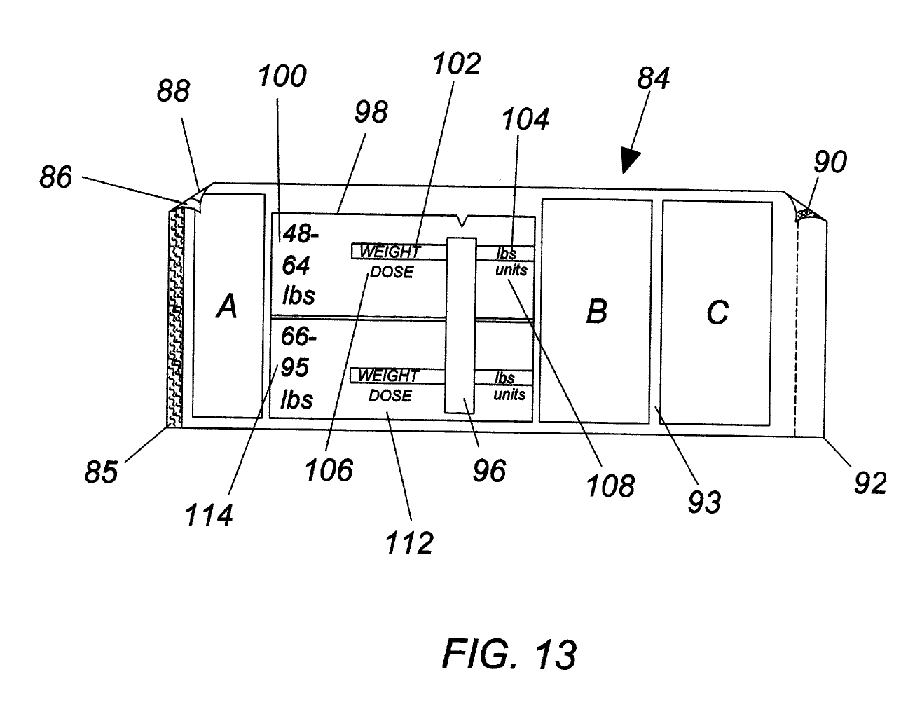

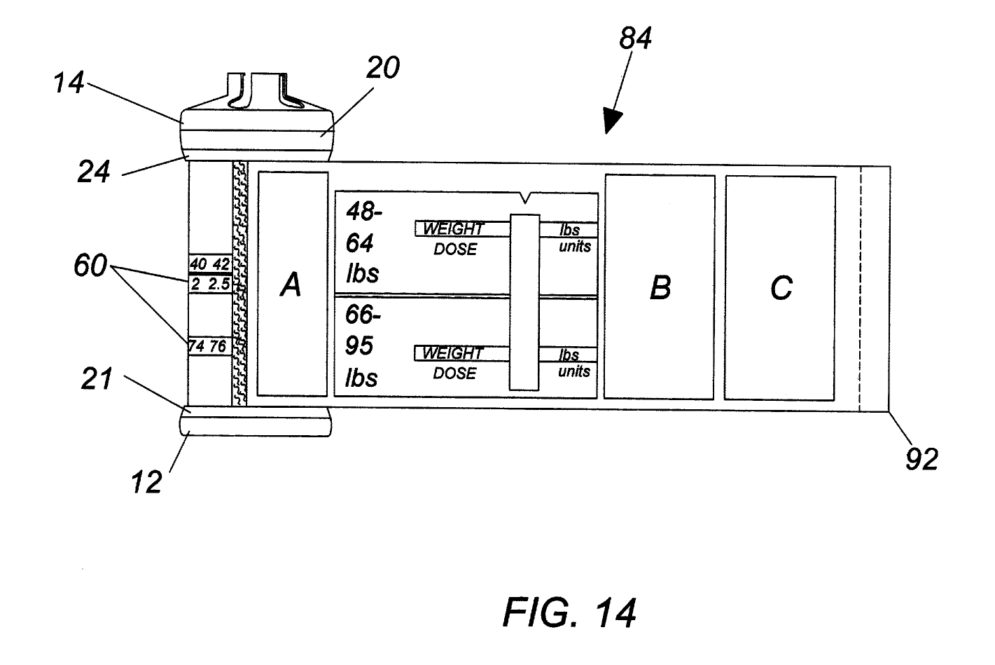

Referring now to FIGS. 13-14, set forth is the upper label 84 having a leading edge 85 having temporary adhesive dot placed along the back surface 88 thereof and an area of permanent adhesive 90 placed along the back surface 88 of the trailing edge 92. The outer label 84 is wrapped around the inner label 60 allowing the adhesive 90 to be placed along the back surface 88 of the trailing edge 92 to overlap the front surface 93 of the leading edge 94 of the outer label 84, and be attached thereto. The temporary adhesive dot 86 will dry and disintegrate within twenty four hours of application wherein the adhesive bond is lost. The adhesive placed along the back surface 88 of the trailing edge 92 will dry with a permanent adhesion to the frontal surface 93 of the outer label 84. The outer label 84 can then be rotated which will easily break any bond left with the temporary adhesive dot 86 allowing the outer label 84 to be rotated relative to the inner label 60. One skilled in the art will recognize that various types of adhesive can be used to accomplish the intended results, further the location of the adhesive need not be on the exact positions depicted yet still accomplish the same result. For instance, the leading edge of the outer label may have an adhesive dot 86 placed on the back surface 88 and the adhesive strip placed on the trailing edge 92 of the front side surface 93.

The leading edge 94 is temporarily attached to the inner label 60 by the adhesive dot 86 allowing the label 84 to wrap around the inset sidewall 16 of the top loading container until the trailing edge 92 overlaps the leading edge 94 wherein the permanent adhesive 90 attaches to bond the label in a continuous loop. In this manner the temporary adhesive 86 maintains the outer label in position only until it dries and dissolves wherein outer label 84 is free to rotate around the inner label 60. The outer label includes a window aperture 96 that is constructed and arranged to be placed over the calculation aid indicia so as to reveal only the indicia as specified by the label. By way of example, outer label 84 is shown with an upper box 98 having a description of weight 100 showing a weight row 102 depicting the measurement term 104 which in this example is lbs. A second row describing the dose 106 and the unit size 108 which in this example is units. The label 84 is rotated to allow the window 96 to be placed over the 44 lbs weight indicating a dosage rate 92 of 2.5 units. Similarly a second level of indicia 110 indicates a weight of 78 lbs and a dosage rate of 6.5 units 96.

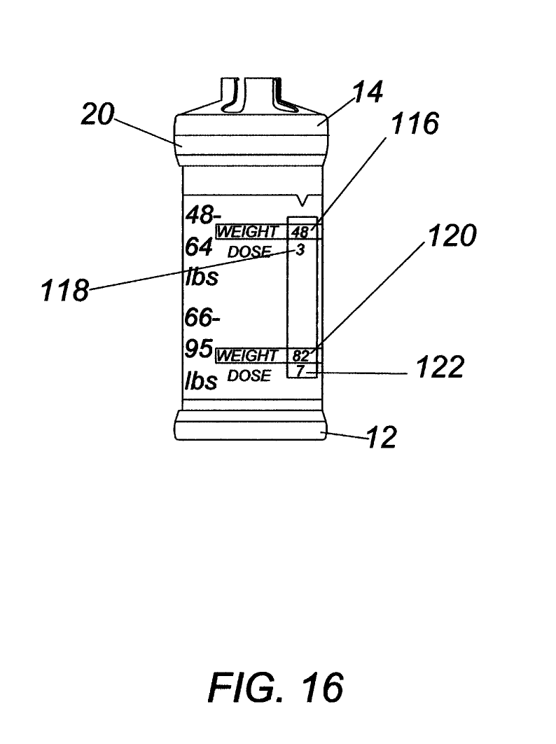

The outer label 84 includes sufficient area so that descriptions can be added in various sections A, B, & C without the need for miniaturization of print. To further enhance the readability of the label, weight columns 74 and 78 may be shaded or placed in a color to correspond with the weight row 102 and lbs row 104 assuring that the alignment of the word “weight” the weight amount, and the “units” in lbs can be easily distinguished. The dosage label, the amount, and the label may be un-shaded for ease of readability. The dosage box 98 may include a single window 110 or may include a second box 112 which duplicates the first box with a different weight amount 114. As shown in FIG. 16 the outer label 84 can be rotated so that the window aperture 96 now depicts the weight 116 of 48 lbs with a dosage 118 of 3 units and the second box depicts a weight of 82 lbs 120 with a dosage rate 122 of 7 units.

For example, an individual with Type 1 diabetes requires daily doses of insulin to keep blood glucose levels from going too high. Insulin is a hormone produced by the beta cells of the pancreas that permits glucose to enter cells and helps the body use glucose for energy. People who are Type 1 diabetic must use manufactured insulin, usually in an injectable form, to replace the natural insulin that is no longer produced by their body. At mealtime the individual may calculate the carbohydrate coverage insulin dose at a meal, wherein the CHO insulin dose=Total grams of CHO in the meal÷grams of CHO disposed by 1 unit of insulin (the grams of CHO disposed of by 1 unit of insulin is the bottom number or denominator of the Insulin:CHO ratio). Thus, if an individual having type 1 diabetes plans for 60 grams of carbohydrate for lunch wherein their Insulin CHO ratio is 1:10. The CHO insulin dose=Total grams of CHO in the meal (60 g)÷grams of CHO disposed by 1 unit of insulin (10)=6 units. The individual will need 6 units of rapid acting insulin to cover the carbohydrate. The base line indicia can be displayed in the form carbohydrate levels allowing the individual to determine insulin dosage rate without further calculation aid.

By weight, basal and bolus doses for an estimated daily insulin dose is made by calculating the Total Daily Insulin Requirement (in units of insulin)=Weight in Pounds÷4. Assuming a child weights 80 lbs the total insulin dose=80 lb÷4=20 units of insulin/day. The indicia can track weight allowing the individual to determine dosage without further calculation aid.

Common children's injectables that are determined by weight include, by way of example:

NeoProfin—Ibuprofen, a nonsteroidal anti-inflammatory drug. Dosing, having a weight greater than or equal to 0.5 kg and less than 1.5 Kg: 10 mg/kg IV initial dose, followed by two doses of 5 mg/kg each, after 24 hours and 48 hours.

Avinza—Morphine, a narcotic pain medication. Dosing to Pediatric=0.5 mg/kg with a Max Dose: 0.1 mg/kg. Greater than or equal to 1 month, but less than 12 years: 0.005-0.02 mg/kg IM.

Dilaudid—Hydromorphone, a narcotic pain medication has an initial dose: 0.001 mg/kg; from 1-12 years=0.015 mg/kg initial dose.

Dilantin—Phenytoin, an antiepileptic drug. Initially, 5 mg/kg/day in two or three equally divided doses, with subsequent dosage individualized to a maximum of 300 mg daily. A recommended daily maintenance dosage is usually 4 to 8 mg/kg. Children over 6 years old and adolescents may require the minimum adult dose (300 mg/day).

Fuzeon—enfuvirtide, an antiviral medication in a group of HIV medicines. In pediatric patients 6 years through 16 years of age, the recommended dosage is 2 mg/kg twice daily up to a maximum dose of 90 mg twice daily injected subcutaneously into the upper arm, anterior thigh or abdomen.

Garamycin—Gentamicin an antibiotic having Pediatric Dose for Bacterial Infection: 0 to 4 weeks, birthweight<1200 g: 2.5 mg/kg IV or IM every 18 to 24 hours; 0 to 1 week, birthweight>=1200 g: 2.5 mg/kg IV or IM every 12 hours; 1 to 4 weeks, birthweight 1200 to 2000 g: 2.5 mg/kg IV or IM every 8 to 12 hours; 1 to 4 weeks, birthweight>=2000 g: 2.5 mg/kg IV or IM every 8 hours; and >1 month: 1 to 2.5 mg/kg IV or IM every 8 hours. Usual Pediatric Dose for Bacterial Endocarditis Prophylaxis 1.5 mg/kg IV or IM once within 30 minutes of starting the procedure. For high risk patients, in addition to gentamicin, ampicillin 50 mg/kg (maximum 2 G) is given IV or IM 30 minutes prior to the procedure, followed by ampicillin 25 mg/kg IV/IM or amoxicillin 25 mg/kg orally 6 hours later. In penicillin-allergic patients, vancomycin 20 mg/kg IV is infused over 1 to 2 hours instead of ampicillin/amoxicillin.

Increlex—Mecasermin is an insulin-like growth factor-1 (IGF-1)—2 years old to adult (closed epiphyses): initial dose: 0.04 to 0.08 mg/kg twice daily by subcutaneous injection. If well tolerated for at least one week, the dose may be increased by 0.04 mg/kg per dose to the maximum of 0.12 mg/kg given twice daily.

Kefzol—Cefazolin, an antibiotic. Dosing—Postnatal=20 mg/kg; 1 month or older=6.25-25 mg/kg.

Omnitrope—Somatropin, Human Grown Hormone. Pediatric Grown Hormone Deficiency: Generally, a dosage of 0.16-0.24 mg/kg weight/week is recommended. PraderWilli Syndrome: Generally, a dosage of 0.24 mg/kg week is recommended. Small for Gestational Age (SGA): generally, a dosage of up to 0.48 mg/kg body weight/week is recommended.

Rocephin—Ceftriaxone, an antibiotic for the treatment of skin structure infections, the recommended total daily dose is 50 to 75 mg/kg given once a day. For the treatment of acute bacterial otitis media, a single intramuscular dose of 50 mg/kg. For the treatment of serious miscellaneous infections, the recommended total daily dose is 50 to 75 mg/kg, given in divided doses every 12 hours (total daily dose should not exceed 2 grams). In the treatment of meningitis, the recommended initial dose is 100 mg/kg.

The examples illustrate but a few use of the calculation aid and demonstrate that even a trained medical profession is confronted with numerous injectables that have dissimilar dosing requirements. Further, this application is not limited to the type of medication or the use of either an insulated container or cushioned container further allows the fluid vials to hold most any type of fluid that benefits from a calculation chart or table. In addition, the label may contain other indicia as well, including the identification and other important information regarding the contents of the fluid within the vial. For fluid vials stored within the top loading container 10 which do not have a labeled attached thereto, the top loading container 10 becomes the primary source of content information. In cases of a drug, the name, dosing, side effects, and proper methods of taking the drug, or any handling instructions can be may be listed. In cases where the contents stored within the top loading container 10 are light sensitive, the container may be made of a materials that prevents contact with light or may be colored to minimize light penetration.

The inner label 60 and outer label 84 can be made of paper or plastic film or any other appropriate material. A plastic label, or plastic film, provides for ease of use with the plastic file allowing ease of rotation. The paper label allows for individualized printing by a caregiver from a conventional printer to allow customization of the level to a particular dosing rate. For instance, if combination of medications can be combined, the caregiver may prepare a dosage rate specifically for a patient. A computer software program allows for the inclusion of specific instructions onto the inner and outer label, the program employing a template that assures proper alignment of the base indicia and dosage rate. A kit can be provided which includes laser or ink jet labels, template software, and container blanks to allow proper positioning of all indicia in relation to the label opening aperture of the instant invention.

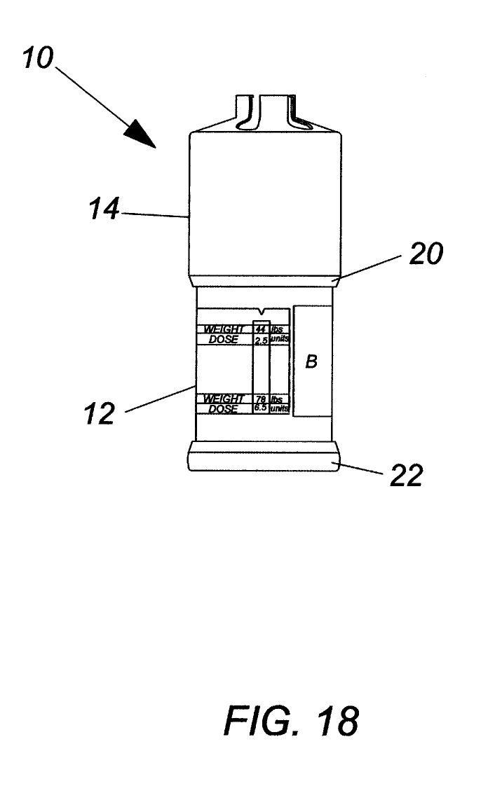

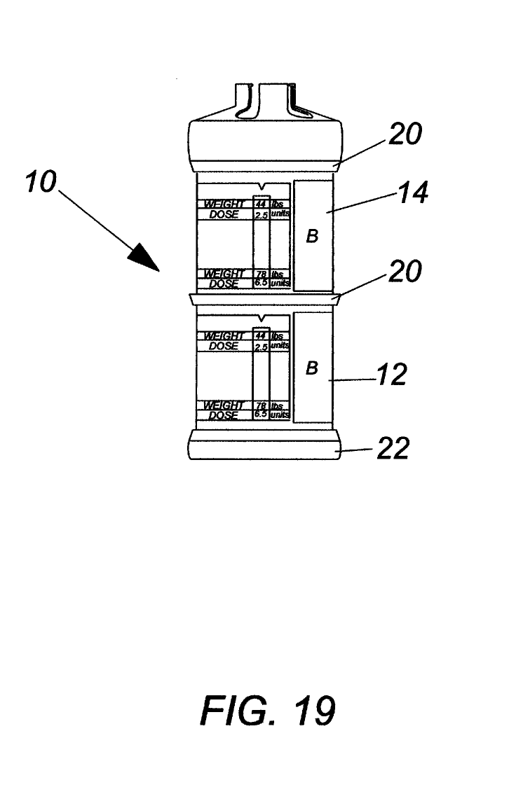

FIG. 18 depicts a second embodiment of the top loading container 10 for housing an injectable fluid vial housing 220 wherein the second upper portion 14 is constructed to have a continuous outer upper wall 38 which forms a larger portion of the top loading container 10 when the first lower portion 12 and the second upper portion 14 are secured together. This embodiment illustrates an upper portion 14 contributing a larger outer surface area for which labeling may be also attached that described previously. Traditional labeling may be utilized for this purpose. Alternatively, the labeling described herein can be used. FIG. 19 shows an illustrative example of the top loading container 10 having dual rotating labels. The top loading container 10 contains the first upper portion 12 and the second upper portion 14 secured together as described before. The first lower portion 12 and the second upper portion 14 are adapted to form a first continuous inset side wall 124 and a second continuous inset side wall 126, similar to the previously described embodiment, including transition sites. The first side wall 124 forms at least part of the second upper portion 14. While the top loading container is designed to prevent separation between the first lower portion 12 and the second upper portion 14, should separation occur each half would contain identification to allow the user to easily identify both parts. For non-labeled fluid vials stored within the top loading container 10, dual labels prevent the fluid vial from being mislabeled, placed on the wrong bottom portion should separation occur, or from being discarded because the user is unaware of the actual contents in the vial.

While detailed embodiments of the instant invention are disclosed herein, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An outer container for a fluid vial housing comprising:
a lower portion having a bottom, a top, and an inset continuous side wall therebetween, said top adapted to receive and secure an upper portion thereto,
an upper portion having an opening constructed and arranged to receive and suspend a fluid vial housing in a relatively fixed position, said upper portion adapted to be securable to said lower portion to form an interior portion of an enclosed container, said fluid vial being suspended within said enclosed container.

2. The container for a fluid vial housing according to claim 1 wherein said fluid vial housing is an injectable fluid vial housing.

3. The container for a fluid vial housing according to claim 1 wherein said sidewall is inset a distance at a right angle to the outer surface of said top and said bottom.

4. The container for a fluid vial housing according to claim 1 wherein said upper portion is adapted to position said injectable fluid vial within said interior portion such that a distance between said injectable fluid vial and said inset continuous side wall is maintained.

5. The container for a housing according to claim 2 further including:
an inner label defined by a back surface and a front dosing surface, said back surface having a first permanent adhesive for securement to said inset continuous side surface, said dosing surface having at least one row of dosing indicia with base line indicia selected from the group of weight, age, fluid volume or area;
an outer label defined by a rear surface and a front surface with a leading edge and a trailing edge, at least one transparent window located between said leading and trailing edge;
a temporary adhesive attached to said rear surface leading edge of said outer label, said temporary adhesive providing temporary securement of said outer label to said inner label;
a second permanent adhesive attached to said front surface leading edge of said outer label, said outer label wrapped around said inner label with said rear surface trailing edge adhering to said front surface outer edge;
wherein said temporary adhesive disintegrates allowing said outer label to rotate about said inner label whereby said transparent window allows selective viewing of said dosing and base line indicia.

6. The container for a fluid vial housing according to claim 5 wherein said base line indicia is selected from the group consisting of weight, age, fluid volume or area.

7. The container for a fluid vial housing according to claim 1 wherein said fluid vial is inserted through an opening in said top.

8. The container for a fluid vial housing according to claim 7 wherein said opening contains a plurality of finger like protrusions arranged to form a neck.

9. The container for a fluid vial housing according to claim 1 including a tamper resistant seal, said seal enclosing said fluid vial within said container.

10. The container for a fluid vial housing according to claim 1 wherein said fluid vial stored therein contains a safety seal ring.

11. The container for a fluid vial housing according to claim 10 wherein said upper portion secures to said fluid vial stored therein above said safety ring.

12. The container for a fluid vial housing according to claim 10 wherein said upper portion secures to said fluid vial stored therein below said safety ring.

13. The container for a fluid vial housing according to claim 10 wherein said upper portion secures directly to said safety ring.

14. The container for an injectable fluid vial housing according to claim 1 including a means for keying said vial housing to said container.

15. The container for an injectable fluid vial housing according to claim 14 wherein said means for keying is the placement of indicia on the fluid vial housing that replicates indicia place on the front surface of said outer label.

16. The container for a fluid vial housing according to claim 1 wherein said container is insulated to maintain fluid at a prolonged constant temperature.

17. The container for a fluid vial housing according to claim 1 wherein said temporary adhesive disintegrates within 24 hours from application to said outer label.

18. The container for a fluid vial housing according to claim 1 wherein said upper portion and said lower portion is made of an opaque or translucent material.

19. A container for an injectable fluid vial housing comprising:
a container formed in the shape of an enclosed bottle, said container having an lower portion coupled to an upper portion to forming a bottom section, a top section, and a side wall therebetween, said container constructed and arranged to receive and maintain an injectable fluid vial housing in a suspended state therein;
an inner label defined by a back surface and a front dosing surface, said back surface having a first permanent adhesive for securement to said sidewall, said dosing surface having at least one row of dosing indicia with base line indicia selected from the group of weight, age, fluid volume or area;
an outer label defined by a rear surface and a front surface with a leading edge and a trailing edge, at least one transparent window located between said leading and trailing edge;
a temporary adhesive attached to said rear surface leading edge of said outer label, said temporary adhesive providing temporary securement of said outer label to said inner label;
a second permanent adhesive attached to said front surface leading edge of said outer label, said outer label wrapped around said inner label with said rear surface trailing edge adhering to said front surface outer edge;
wherein said temporary adhesive disintegrates allowing said outer label to rotate about said inner label whereby said transparent window allows selective viewing of said dosing and base line indicia.

20. The container for an injectable fluid vial housing according to claim 19 including a means for keying said vial housing to said container.

21. The container for an injectable fluid vial housing according to claim 20 wherein said means for keying is the placement of indicia on the fluid vial housing that replicates indicia place on the front surface of said outer label.

22. The container for an injectable fluid vial housing according to claim 19 wherein said container is insulated to maintain fluid at a prolonged constant temperature.

23. The container for an injectable fluid vial housing according to claim 19 wherein said label operates as a tamper-evident shield to said container.

24. The container for an injectable fluid vial housing according to claim 20 wherein said temporary adhesive disintegrates within 23 hours from application to said outer label.

25. The container for an injectable fluid vial housing according to claim 19 further including a cushioning member.
